(19) United States
(12) Patent Application Publication
(10) Pub. No.: US 2016/0291376 A1
(43) Pub. Date: Oct. 6, 2016

(54) DISPLAY DEVICE

(71) Applicant: InnoLux Corporation, Miao-Li County (TW)

(72) Inventors: Akihiro IWATSU, Miao-Li County (TW); Sheng-Feng HUANG, Miao-Li County (TW)

(21) Appl. No.: 14/672,518

(22) Filed: Mar. 30, 2015

(51) Int. Cl. G02F 1/1343; G02F 1/1335

(52) U.S. Cl. CPC G02F 1/13439; G02F 1/134309; G02F 1/133512; G02F 2001/133388

(57) ABSTRACT

A display device is provided. The display device includes a display region and a non-display region adjacent to the display region, wherein the display region is non-rectangular and includes a plurality of first pixels and a plurality of second pixels, wherein the plurality of second pixels is disposed at the periphery of the display region and surrounds the plurality of first pixels, wherein when the plurality of first pixels and the plurality of second pixels are supplied with the same operating voltage, the plurality of second pixels has two or more brightness levels.

### BACKGROUND

1. Technical Field

The disclosure relates to a display device, and in particular to a display device with pixels having two or more brightness levels.

2. Description of the Related Art

Display devices are becoming more widely used as display elements in various products. Liquid-crystal molecules have different light polarization or light refraction effects at different alignment configurations, and liquid-crystal display devices utilize this characteristic to control light penetration and generate images. Conditional twisted nematic liquid-crystal display devices have good light penetration characteristics. However, they cannot provide a sufficient aperture ratio or viewing angle due to their pixel design and structure, and due to the optical characteristics of the liquid-crystal molecules.

In order to solve this problem, various liquid-crystal display devices with wide-angle viewing and high aperture ratios have been developed, such as the in-plane switching liquid-crystal display device, and the fringe-field switching liquid-crystal display device. However, existing display quality has not been satisfactory in every respect.

Therefore, a display device with an improved display quality is needed.

### SUMMARY

The present disclosure provides a display device, including: a display region and a non-display region adjacent to the display region, wherein the display region is non-rectangular and includes a plurality of first pixels and a plurality of second pixels, wherein the plurality of second pixels is disposed at the periphery of the display region and surrounds the plurality of first pixels, wherein when the plurality of first pixels and the plurality of second pixels are supplied with the same operating voltage, the plurality of second pixels has two or more brightness levels.

A detailed description is given in the following embodiments with reference to the accompanying drawings.

### BRIEF DESCRIPTION OF THE DRAWINGS

The disclosure can be more fully understood by reading the subsequent detailed description and examples with references made to the accompanying drawings, wherein:

FIG. 1A is a top view of a display device in accordance with some embodiments of the present disclosure;

FIG. 1B is a top view of a display device in accordance with another embodiment of the present disclosure;

FIG. 1C is a top view of a display device in accordance with yet another embodiment of the present disclosure;

FIGS. 2A-2E are top views of sub-pixels in accordance with some embodiments of the present disclosure;

FIGS. 3A-3E are top views of sub-pixels in accordance with another embodiment of the present disclosure;

FIG. 4A is a top view of a pixel in accordance with yet another embodiment of the present disclosure;

FIGS. 4B-4F are cross-sectional views of display devices in accordance with yet another embodiment of the present disclosure;

FIGS. 5A-5E are top views of pixels in accordance with a further embodiment of the present disclosure;

FIG. 6 is a cross-sectional view of a display device in accordance with a further embodiment of the present disclosure; and

FIG. 7 is an image of a display device.

### DETAILED DESCRIPTION

The display device of the present disclosure is described in detail in the following description. In the following detailed description, for purposes of explanation, numerous specific details and embodiments are set forth in order to provide a thorough understanding of the present disclosure. The specific elements and configurations described in the following detailed description are set forth in order to clearly describe the present disclosure. It will be apparent, however, that the exemplary embodiments set forth herein are used merely for the purpose of illustration, and the inventive concept can be embodied in various forms without being limited to those exemplary embodiments. In addition, the drawings of different embodiments can use like and/or corresponding numerals to denote like and/or corresponding elements in order to clearly describe the present disclosure. However, the use of like and/or corresponding numerals in the drawings of different embodiments does not suggest any correlation between different embodiments. In addition, in this specification, expressions such as “first insulating bump disposed on/over a second material layer”, can indicate the direct contact of the first insulating bump and the second material layer, or it can indicate a non-contact state with one or more intermediate layers between the first insulating bump and the second material layer. In the above situation, the first insulating bump can not directly contact the second material layer.

It should be noted that the elements or devices in the drawings of the present disclosure can be present in any form or configuration known to those skilled in the art. In addition, the expression “a layer overlying another layer”, “a layer is disposed above another layer”, “a layer is disposed on another layer” and “a layer is disposed over another layer” can indicate that the layer directly contacts the other layer, or that the layer does not directly contact the other layer, there being one or more intermediate layers disposed between the layer and the other layer.

In addition, in this specification, relative expressions are used. For example, “lower”, “bottom”, “higher” or “top” are used to describe the position of one element relative to another. It should be appreciated that if a device is flipped upside down, an element that is “lower” will become an element that is “higher”.

The terms “about” and “substantially” typically mean +/−20% of the stated value, more typically +/−10% of the stated value, more typically +/−5% of the stated value, more typically +/−3% of the stated value, more typically +/−2% of the stated value, more typically +/−1% of the stated value and even more typically +/−0.5% of the stated value. The stated value of the present disclosure is an approximate value. When there is no specific description, the stated value includes the meaning of “about” or “substantially”.

It should be understood that, although the terms first, second, third etc. can be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present disclosure.

Unless defined otherwise, all technical and scientific terms used herein have the same meaning as commonly understood by one of ordinary skill in the art to which this disclosure belongs. It should be appreciated that, in each case, the term, which is defined in a commonly used dictionary, should be interpreted as having a meaning that conforms to the relative skills and the background or the context of the present disclosure, and should not be interpreted in an idealized or overly formal manner unless so defined.

Through altering the brightness levels of the pixels disposed at the periphery of the display region in the display device, the present disclosure can display a non-rectangular display border without a micro jigsaw border or a micro zigzag border and thus further improve the display quality of the display device.

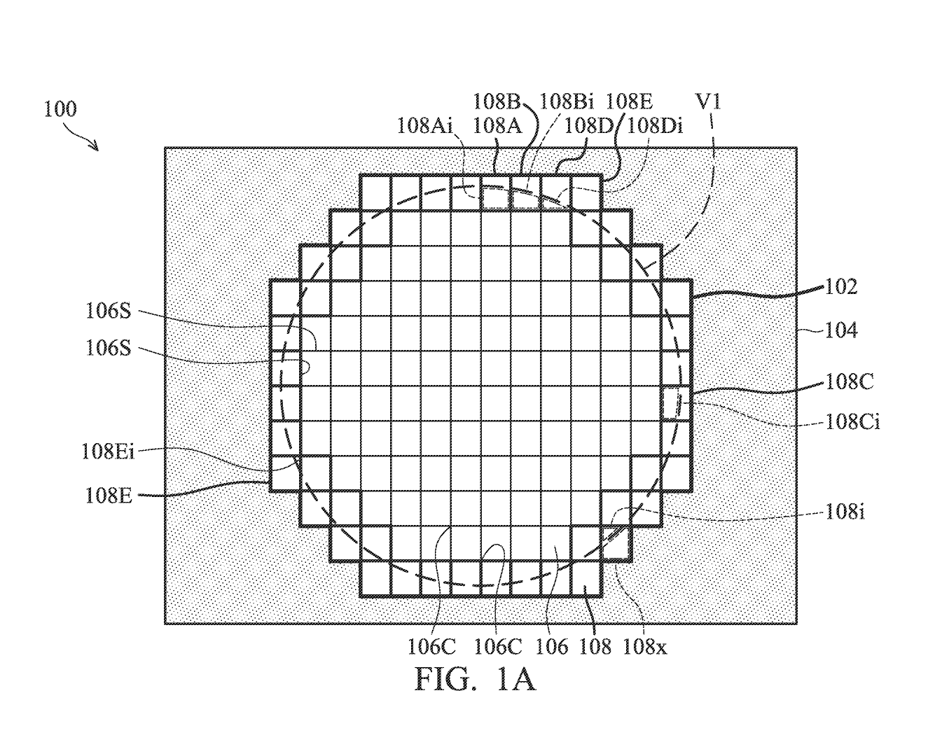

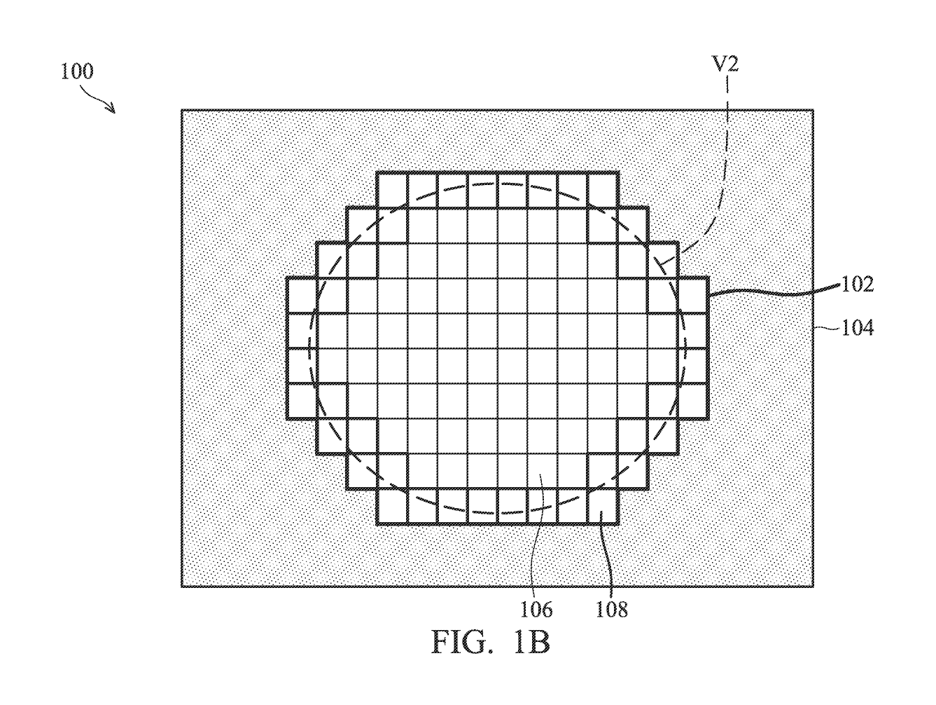

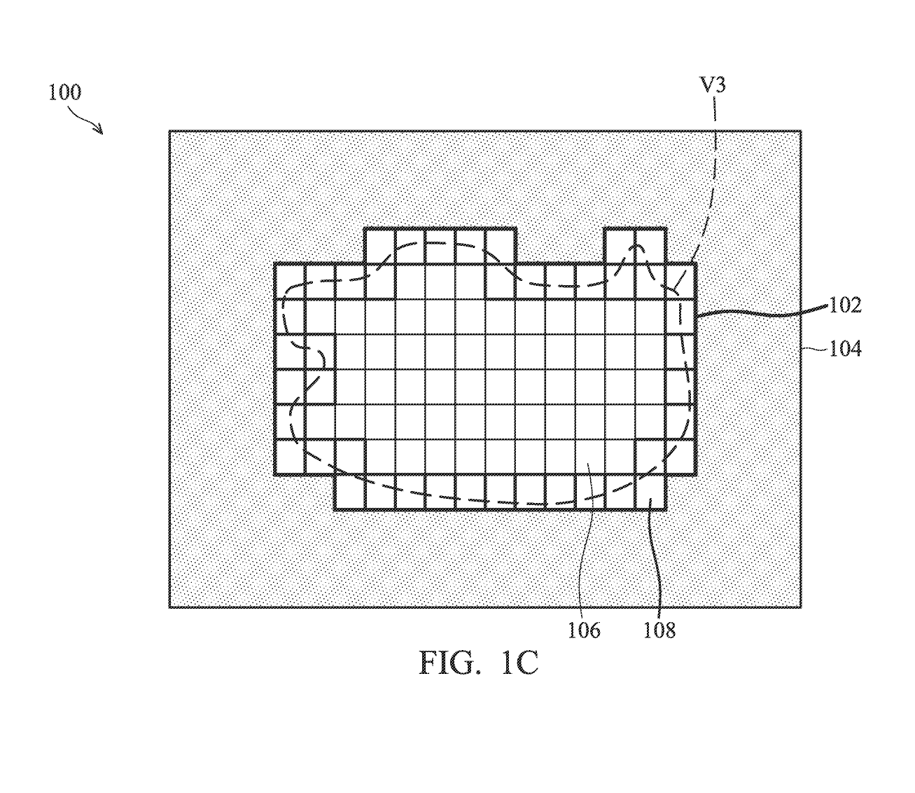

FIG. 1A is a top view of a display device in accordance with some embodiments of the present disclosure. Referring to FIG. 1A, the display device 100 includes a display region 102 and a non-display region 104 adjacent to the display region 102. In this embodiment, the non-display region 104 surrounds or encloses the display region 102. The display region 102 refers to the region in the display device 100 in which the pixel including transistor is disposed and displays, and thus the display region 102 is also referred to as a pixel-displaying region. The transistor can include, but is not limited to, a thin film transistor. The non-display region 104 refers to the region other than the display region 102 in the display device 100. In one embodiment, the display region 102 can be non-rectangular.

The display device 100 can include, but is not limited to, a liquid-crystal display such as a thin film transistor liquid-crystal display. Alternatively, the liquid-crystal display can include, but is not limited to, a twisted nematic (TN) liquid-crystal display, a super twisted nematic (STN) liquid-crystal display, a double layer super twisted nematic (DSTN) liquid-crystal display, a vertical alignment (VA) liquid-crystal display, an in-plane switching (IPS) liquid-crystal display, a cholesteric liquid-crystal display, a blue phase liquid-crystal display, or any other suitable liquid-crystal display.

Referring to FIG. 1A, the display region 102 includes a plurality of first pixels 106 and a plurality of second pixels 108, and the plurality of second pixels 108 is disposed at the periphery of the display region 102 and surrounds the plurality of first pixels 106. In this embodiment, the plurality of second pixels 108 can completely enclose the plurality of first pixels 106. In other words, the sides 106S of each first pixel 106 can only contact other first pixels 106 or the second pixels 108, and do not contact the non-display region 104. More specifically, the corners 106C of each first pixel 106 can only contact other first pixels 106 or the second pixels 108, and do not contact the non-display region 104. In addition, each first pixel 106 and second pixel 108 includes at least three sub-pixel of different color.

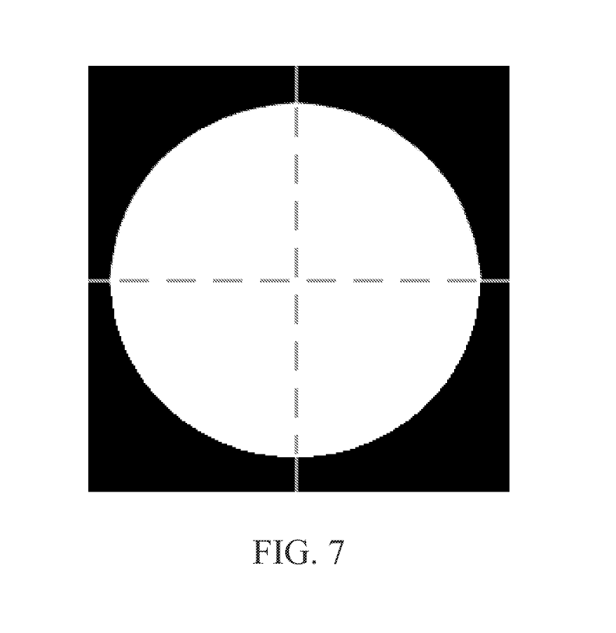

In the present disclosure, when the plurality of first pixels 106 and the plurality of second pixels 108 are supplied with the same operating voltage, the plurality of second pixels 108 has two or more brightness levels. By altering the brightness levels of the second pixels 108 disposed at the periphery of the display region 102 in the display device 100, the present disclosure can display a non-rectangular display border without a micro jigsaw border or a micro zigzag border, which is shown in the subsequent FIG. 7. Therefore, the display quality of the display device can be improved further.

In addition, in some embodiments, when the plurality of first pixels 106 and the plurality of second pixels 108 are supplied with the same operating voltage, all the first pixels 106 have the maximum brightness (i.e. the subsequent first brightness level), and the second pixels 108 have two or more brightness levels with the brightness equal to or less than the maximum brightness of the first pixels 106.

Referring to FIG. 1A, the display device 100 can further include a virtual edge curve V1 across the plurality of second pixels 108. The virtual edge curve V1 divides each second pixel 108 into an inner region 108i and an outer region 108x. The inner region 108i of the second pixel 108 is closer to the plurality of first pixels 106 and the outer region 108x of the second pixel 108 is farther away from the plurality of first pixels 106.

In addition, the virtual edge curve V1 defines the non-rectangular display border. In other words, the virtual edge curve V1 is the non-rectangular display border, which encloses a non-rectangular display region. As shown in FIG. 1A, the non-rectangular display region enclosed by the virtual edge curve V1 (the non-rectangular display border) includes all the first pixels 106 and a portion of each second pixel 108. In other words, the non-rectangular display region includes all the first pixels 106 and all the inner regions 108i of all second pixel 108, and does not include the outer region 108x of the second pixel 108.

In this embodiment, the virtual edge curve V1 is a circle. In addition, the virtual edge curve V1 can only pass through the plurality of second pixels 108 and does not pass through the non-display region 104 and the plurality of first pixels 106.

In the present disclosure, when the plurality of first pixels 106 and the plurality of second pixels 108 are supplied with the same operating voltage, the brightness level of each second pixel 108 is related to the area of the inner region 108i thereof.

For example, in one embodiment, the brightness level of each second pixel 108 can be determined by the following method, which classifies the second pixels 108 into five classes with five brightness levels. In particular, when the plurality of first pixels 106 and the plurality of second pixels 108 are supplied with the same operating voltage, the plurality of first pixels 106 has the first brightness level, which corresponds to the aforementioned maximum brightness of the first and second pixels 106 and 108 under the determined operating voltage.

Referring to FIG. 1A, if the area of the inner region 108Ai of one second pixel 108 is greater than or equal to 0.875 times the total area of the second pixel 108, the second pixel 108 has the first brightness level (i.e. the maximum brightness) and is referred to as a first-brightness level second pixel 108A.

If the area of the inner region 108Bi of one second pixel 108 is greater than or equal to 0.625 times the total area of the second pixel 108 and is less than 0.875 times the total area of the second pixel 108, the second pixel 108 has a second brightness level which is 0.75 times the first brightness level (i.e. the maximum brightness) and is referred to as a second-brightness level second pixel 108B.

If the area of the inner region 108Ci of one second pixel 108 is greater than or equal to 0.375 times the total area of the second pixel 108 and is less than 0.625 times the total area of the second pixel 108, the second pixel 108 has a third brightness level which is 0.5 times the first brightness level (i.e. the maximum brightness) and is referred to as a third-brightness level second pixel 108C.

If the area of the inner region 108Di of one second pixel 108 is greater than or equal to 0.125 times the total area of the second pixel 108 and is less than 0.375 times the total area of the second pixel 108, the second pixel 108 has a fourth brightness level which is 0.25 times the first brightness level (i.e. the maximum brightness) and is referred to as a fourth-brightness level second pixel 108D.

If the area of the inner region 108Ei of one second pixel 108 is less than 0.125 times the total area of the second pixel 108, the second pixel 108 has no brightness level and is referred to as a dark second pixel 108E. In other words, the dark second pixel 108E does not emit light.

Through the above method, the brightness level of each second pixel 108 can be determined by the area of its inner region 108i inside the non-rectangular display region or the virtual edge curve V1 (i.e. non-rectangular display border). Thereby, the more the area of a second pixel 108 is disposed outside the non-rectangular display region or the virtual edge curve V1 (namely the outer region 108x), the lower the brightness level of that second pixel 108 will be. In contrast, the more the area of a second pixel 108 is disposed inside the non-rectangular display region or the virtual edge curve V1 (namely the inner region 108i), the higher the brightness level of that second pixel 108 will be. Therefore, in the present disclosure, the different brightness levels of the second pixels 108 disposed at the periphery of the display region 102 in the display device 100 can display a non-rectangular display border without a micro jigsaw border or a micro zigzag border, which is shown in the subsequent FIG. 7. Therefore, the display quality of the display device can be improved further.

It should be noted that the exemplary method mentioned above is merely for the purpose of illustration. In addition to this exemplary method which classifies the second pixels into five classes with five brightness levels, the second pixels can be classified into other amount of brightness levels by any other suitable method. For example, the brightness level of each second pixel 108 can be determined by another method which classifies the second pixels 108 into six classes with six brightness levels. Since this method is similar to the aforementioned method, this method is only briefly described in the following description for the sake of brevity.

In the method which classifies the second pixels 108 into six classes with six brightness levels, when the plurality of first pixels 106 and the plurality of second pixels 108 are supplied with the same operating voltage, the first pixels 106 also have the first brightness level, which also corresponds to the aforementioned maximum brightness.

Then, if the area of the inner region 108i of one second pixel 108 is greater than or equal to 0.9 times the total area of the second pixel 108, the second pixel 108 has the first brightness level (i.e. the maximum brightness) and is referred to as a first-brightness level second pixel.

If the area of the inner region 108i of one second pixel 108 is greater than or equal to 0.7 times the total area of the second pixel 108 and is less than 0.9 times the total area of the second pixel 108, the second pixel 108 has a second brightness level which is 0.8 times the first brightness level (i.e. the maximum brightness) and is referred to as a second-brightness level second pixel.

If the area of the inner region 108i of one second pixel 108 is greater than or equal to 0.5 times the total area of the second pixel 108 and is less than 0.7 times the total area of the second pixel 108, the second pixel 108 has a third brightness level which is 0.6 times the first brightness level (i.e. the maximum brightness) and is referred to as a third-brightness level second pixel.

If the area of the inner region 108i of one second pixel 108 is greater than or equal to 0.3 times the total area of the second pixel 108 and is less than 0.5 times the total area of the second pixel 108, the second pixel 108 has a fourth brightness level which is 0.4 times the first brightness level (i.e. the maximum brightness) and is referred to as a fourth-brightness level second pixel.

If the area of the inner region 108i of one second pixel 108 is greater than or equal to 0.1 times the total area of the second pixel 108 and is less than 0.3 times the total area of the second pixel 108, the second pixel 108 has a fifth brightness level which is 0.2 times the first brightness level (i.e. the maximum brightness) and is referred to as a fifth-brightness level second pixel.

If the area of the inner region 108i of one second pixel 108 is less than 0.1 times the total area of the second pixel 108, the second pixel 108 has no brightness level and is referred to as a dark second pixel, which does not emit light.

It should be noted that in addition to the exemplary methods mentioned above, the brightness level of each second pixel 108 can be determined by any other suitable method and can be classified into any other amount of brightness levels.

Furthermore, it should be noted that the exemplary embodiment set forth in FIG. 1A is merely for the purpose of illustration. In addition to the embodiment set forth in FIG. 1A, the virtual edge curve can have other shapes as shown in FIGS. 1B-1C. In other words, the virtual edge curve can have one or more curvature radii. Therefore, the inventive concept and scope are not limited to the exemplary embodiment shown in FIG. 1A.

FIG. 1B is a top view of a display device 100 in accordance with another embodiment of the present disclosure. The difference between the embodiments shown in FIGS. 1A and 1B is that the virtual edge curve V2 is an oval with continuously varying curvature radii, rather than a circle with only one curvature radius as shown in FIG. 1A. The curvature radius of one point on the virtual edge curve refers to the curvature radius of a circle which is tangential to that point.

In addition, FIG. 1C is a top view of a display device 100 in accordance with yet another embodiment of the present disclosure. The difference between the embodiments shown in FIGS. 1A and 1C is that the virtual edge curve V3 is a closed curve with two or more different curvature radii, rather than a circle as shown in FIG. 1A.

Subsequently, in one embodiment, the different brightness levels of the first-brightness level second pixel 108A, the second-brightness level second pixel 108B, the third-brightness level second pixel 108C and the fourth-brightness level second pixel 108D can be achieved by altering the overlapping area of a pixel electrode and a semi-opaque semiconductor layer in each second pixel. And the dark second pixel can include a light-shielding layer to completely cover the pixel electrode and completely shield the light emitted from the dark second pixel.

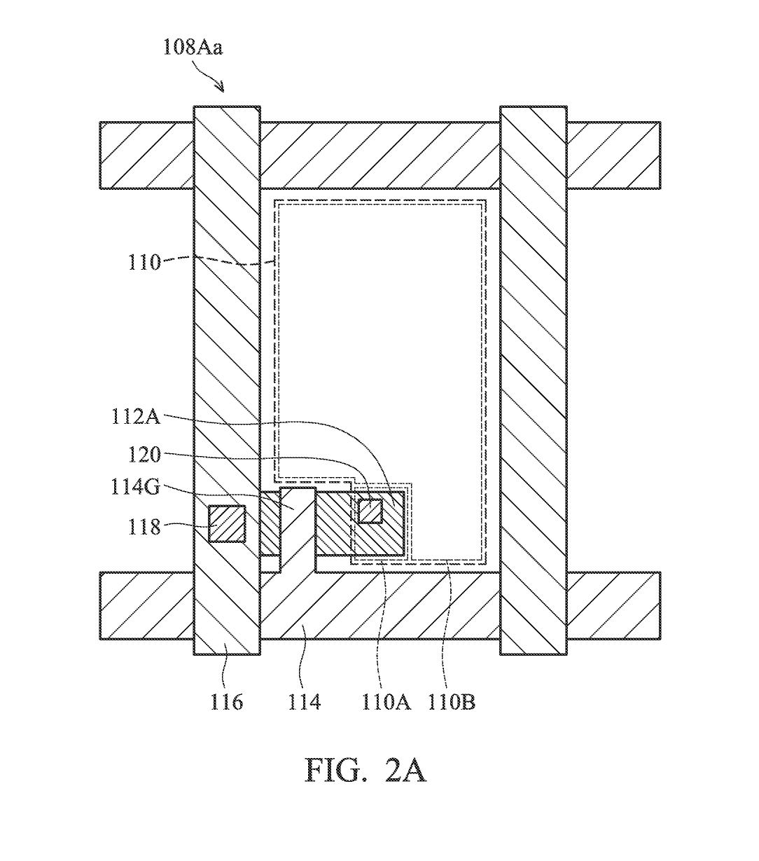

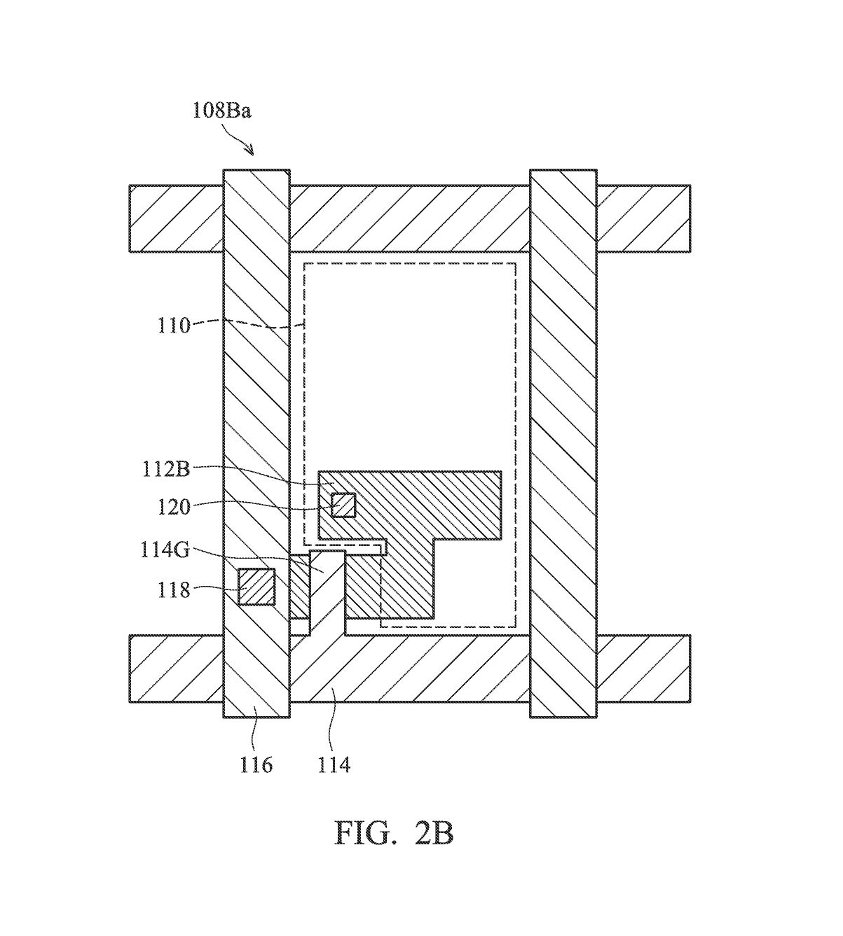

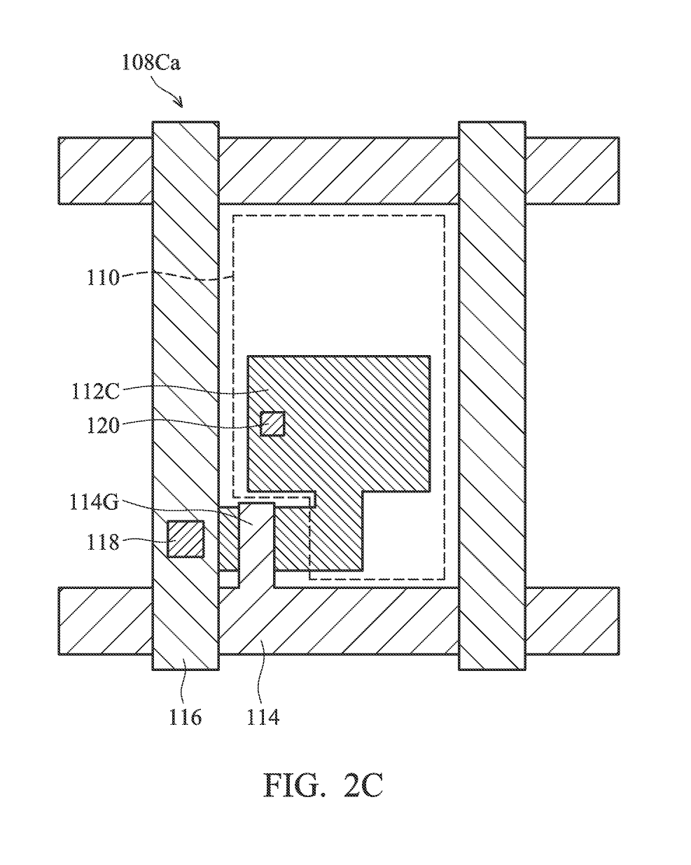

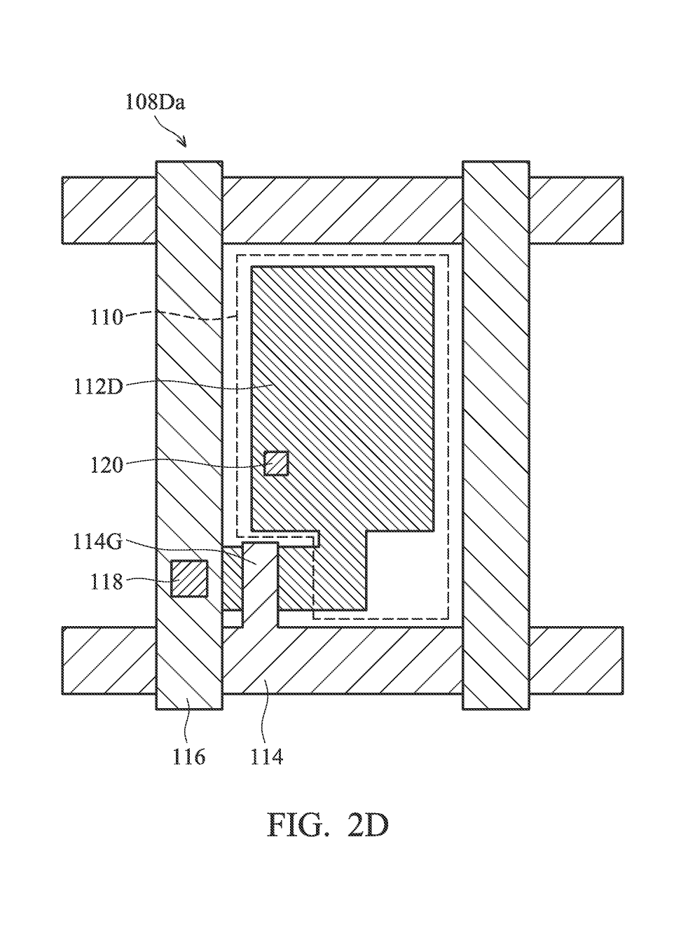

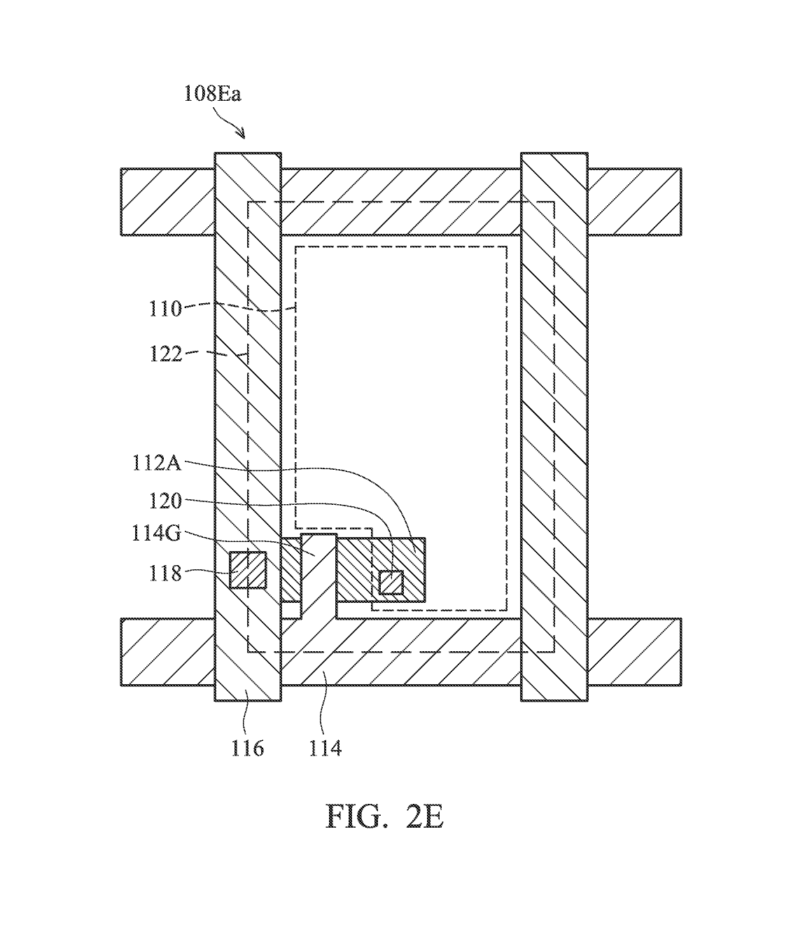

The following description takes the embodiment which utilizes the classification method classifying the second pixels 108 into five classes with five brightness levels for example. FIGS. 2A-2E are top views of sub-pixels 108Aa-108Ea corresponding to first-brightness level second pixel 108A to the dark second pixel 108E in FIG. 1A respectively in accordance with some embodiments of the present disclosure.

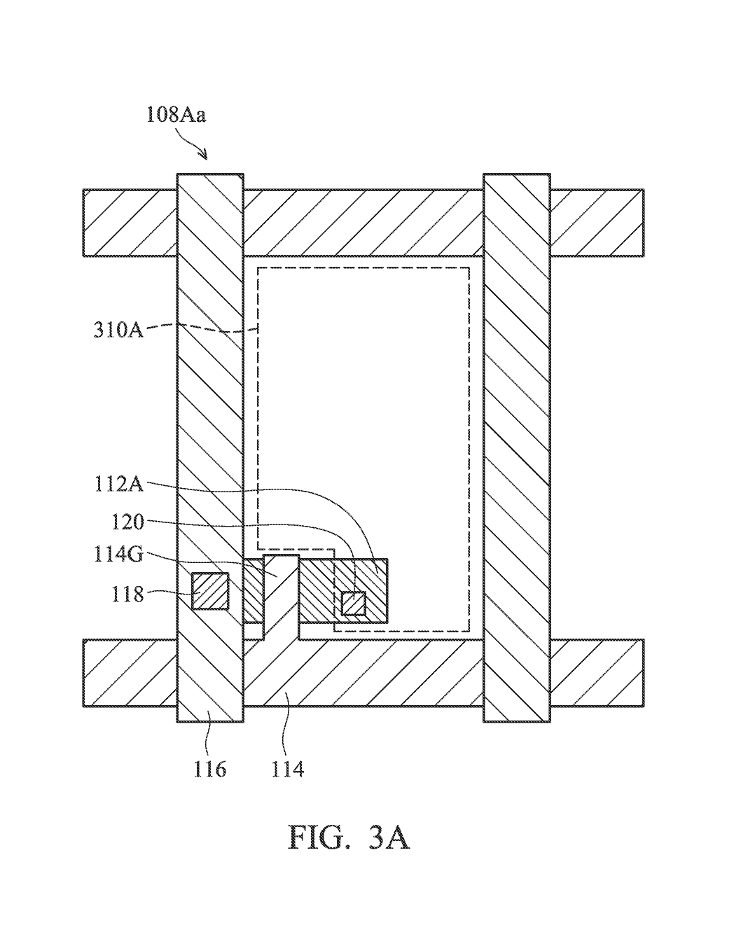

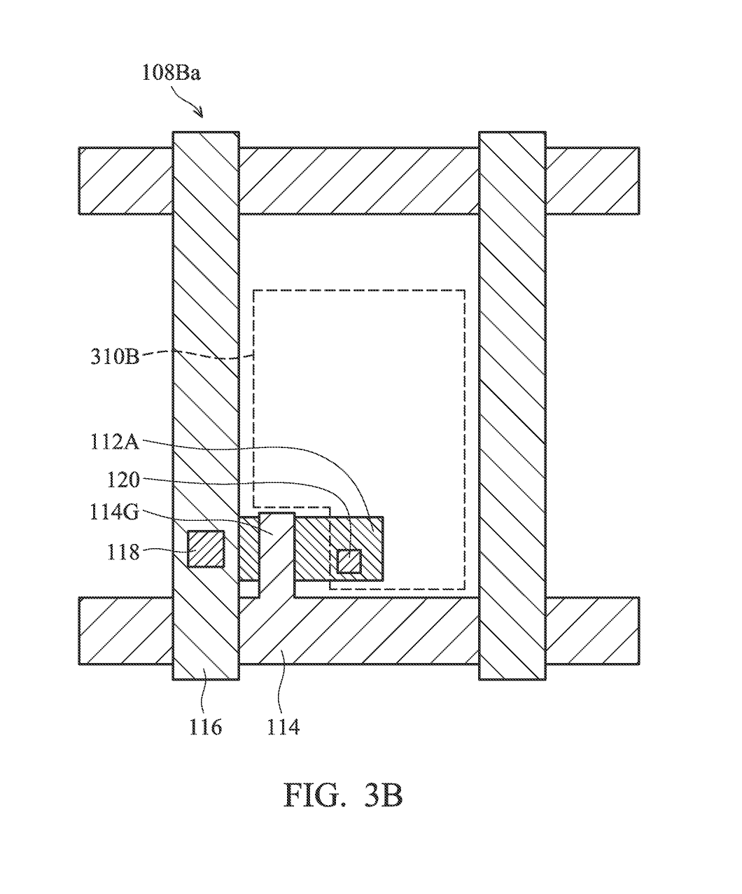

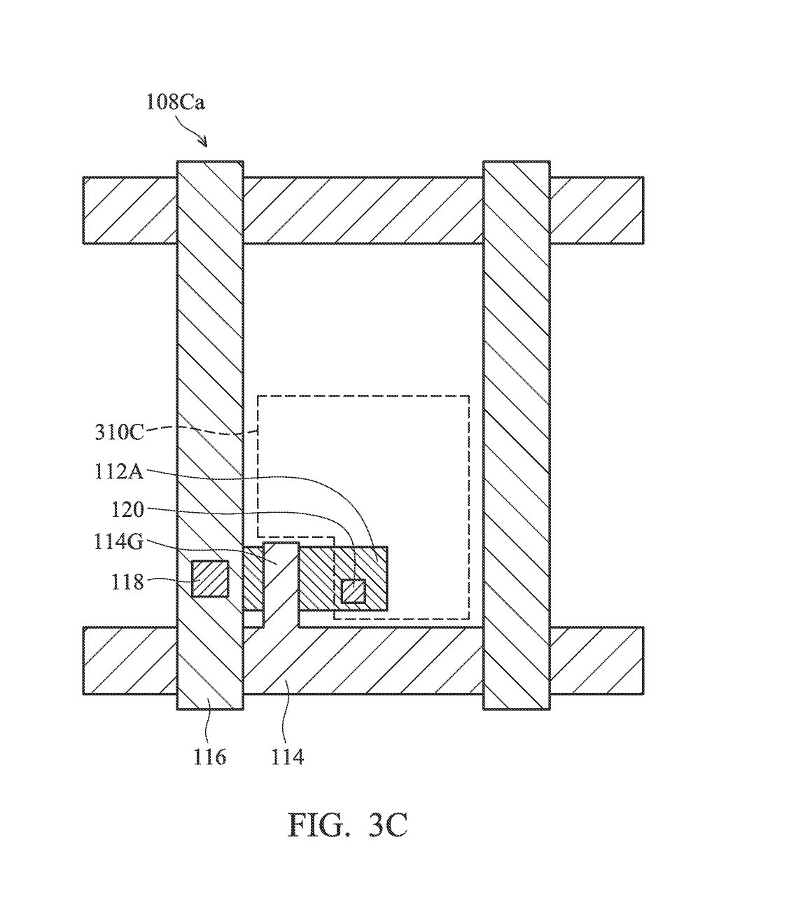

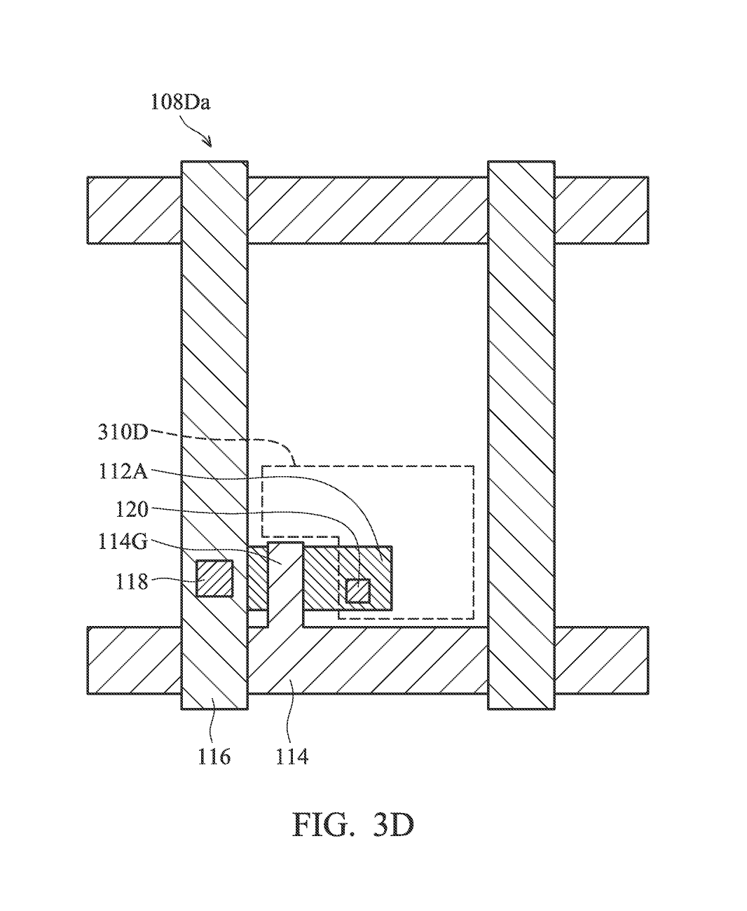

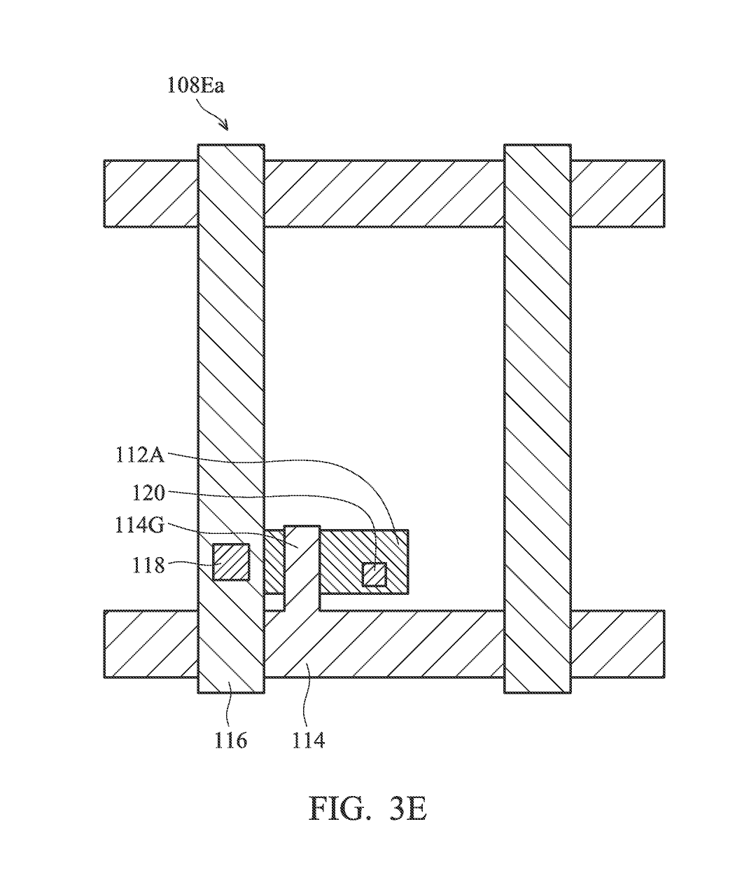

It should be noted that only one sub-pixel is shown for each specific brightness level of the second pixels. For one second pixel with a specific brightness level, the configurations of the other sub-pixels not shown are the same as the configuration of the shown sub-pixel in FIGS. 2A-2E. Therefore, the configuration of one sub-pixel with a specific brightness level shown in FIGS. 2A-2E can represent the overall configuration of the pixel with the specific brightness level, the other sub-pixels of the pixel are omitted for the sake of brevity. In addition, the same concept is applied in FIGS. 3A-3E and will not be repeated again for the sake of brevity.

Referring to FIGS. 2A-2D, each of the second pixels 108 includes a pixel electrode 110 and a semi-opaque semiconductor layer 112A-112D. For second pixels 108 except the dark second pixel 108E, the areas of the pixel electrodes 110 overlapped with the semi-opaque semiconductor layer 112A-112D is inversely related to the area of the inner region. In particular, each of the first-brightness level second pixel 108A, the second-brightness level second pixel 108B, the third-brightness level second pixel 108C and the fourth-brightness level second pixel 108D includes a pixel electrode 110. In addition, each of the first-brightness level second pixel 108A, the second-brightness level second pixel 108B, the third-brightness level second pixel 108C, and the fourth-brightness level second pixel 108D respectively includes a first semi-opaque semiconductor layer 112A, a second semi-opaque semiconductor layer 112B, a third semi-opaque semiconductor layer 112C and a fourth semi-opaque semiconductor layer 112D disposed corresponding to the pixel electrode 110. And areas of the pixel electrodes 110 overlapped with the first semi-opaque semiconductor layer 112A, the second semi-opaque semiconductor layer 112B, the third semi-opaque semiconductor layer 112C or the fourth semi-opaque semiconductor layer 112D are related to the brightness levels of the first-brightness level second pixel 108A, the second-brightness level second pixel 108B, the third-brightness level second pixel 108C, and the fourth-brightness level second pixel 108D.

In particular, the second pixel 108 with a higher brightness level has a smaller overlapping area of the semi-opaque semiconductor layer and the pixel electrode. In addition, second pixels 108 with the same brightness level have the same overlapping area. In addition, in FIGS. 2A-2E, the same or similar elements or layers corresponding to those of the display device are denoted by like reference numerals. The same or similar elements or layers denoted by like reference numerals have the same meaning and will not be repeated for the sake of brevity.

FIG. 2A shows a sub-pixel 108Aa of the first-brightness level second pixel 108A. FIG. 2A also shows a gate line 114 and a data line 116 of the display device 100. The gate line 114 can provide the scanning pulse signal to the sub-pixel 108Aa, and the data line 116 can provide the source signal to the sub-pixel 108Aa, and control the sub-pixel 108Aa in coordination with the aforementioned source signal.

In particular, for the sub-pixel 108Aa shown in FIG. 2A, the source signal in the form of charge can be transmitted sequentially through the data line 116, first conductive via 118, the first semi-opaque semiconductor layer 112A, the second conductive via 120 to the pixel electrode 110. In addition, there is a channel formed in the portion of the first semi-opaque semiconductor layer 112A which is located under and corresponding to the gate electrode portion 114G of the gate line 114. The scanning pulse signal of the gate line 114 can control the state of the channel in the first semi-opaque semiconductor layer 112A, namely the on-state or the off-state. Therefore, the source signal of the data line 116 and the scanning pulse signal of the gate line 114 in coordination can control the amount of charge in the pixel electrode 110, and thereby control the sub-pixel 108Aa.

The pixel electrode 110 can include, but is not limited to, indium tin oxide (ITO), tin oxide (TO), indium zinc oxide (IZO), indium gallium zinc oxide (IGZO), indium tin zinc oxide (ITZO), antimony tin oxide (ATO), antimony zinc oxide (AZO), a combination thereof, or any other suitable materials that are transparent conductive. The first semi-opaque semiconductor layer 112A can include, but is not limited to, poly-silicon, amorphous silicon, indium gallium zinc oxide (IGZO), or a combination thereof, or any other suitable materials that are semi-conductive. In addition, the channel portion of the first semi-opaque semiconductor layer 112A can be an un-doped semiconductor layer, whereas the portion of the first semi-opaque semiconductor layer 112A other than the channel portion can be a heavily doped semiconductor layer such as a semiconductor layer heavily doped with a positive conductive type dopant of a negative conductive type dopant.

In addition, since the semi-opaque semiconductor layer is semi-opaque (i.e. translucent or semi-transparent) and can partially shield the light emitted by the light-emitting element such as a backlight module of the display device, altering the area of the pixel electrode 110 overlapped by the semi-opaque semiconductor layer in each second pixel 108 can achieve the different brightness levels of the second pixels 108.

In particular, the first-brightness level second pixel 108A has the first brightness level (i.e. the maximum brightness). The pixel electrode 110 of the sub-pixel 108Aa of the first-brightness level second pixel 108A includes a first portion 110A which is overlapped with the first semi-opaque semiconductor layer 112A of the sub-pixel 108Aa and a second portion 110B which is not overlapped with the first semi-opaque semiconductor layer 112A. And the first portion 110A has a first area and the second portion 110B has a second area.

Subsequently, FIG. 2B shows a sub-pixel 108Ba of the second-brightness level second pixel 108B, which has the second brightness level which is 0.75 times the first brightness level (i.e. the maximum brightness). The sub-pixel 108Ba (or the second-brightness level second pixel 108B) includes a second semi-opaque semiconductor layer 112B. As illustrated in FIG. 2B, the pixel electrode 110 of the second-brightness level second pixel 108B overlaps with the second semi-opaque semiconductor layer 112B by an area equal to 100% of the first area plus_to_times the second area to achieve the second brightness level which is 0.75 times the first brightness level.

It should be noted that, since the semi-opaque semiconductor layer is not completely opaque, the overlapped area of the pixel electrode 110 and the second semi-opaque semiconductor layer 112B in the second-brightness level second pixel 108B should be more than 100% of the first area plus 25% (0.25) of the second area to achieve the second brightness level which is 0.75 times (75%) the first brightness level. The same concept is applied for the third-brightness level second pixel 108C and the fourth-brightness level second pixel 108D and will not be repeated for the sake of brevity.

FIG. 2C shows a sub-pixel 108Ca of the third-brightness level second pixel 108C, which has the third brightness level which is 0.5 times the first brightness level (i.e. the maximum brightness). The sub-pixel 108Ca (or the third-brightness level second pixel 108C) includes a third semi-opaque semiconductor layer 112C. As illustrated in FIG. 2C, the pixel electrode 110 of the third-brightness level second pixel 108C overlaps with the third semi-opaque semiconductor layer 112C by an area equal to 100% of the first area plus_to_times the second area to achieve the third brightness level which is 0.5 times the first brightness level.

FIG. 2D shows a sub-pixel 108Da of the fourth-brightness level second pixel 108D, which has the fourth brightness level which is 0.25 times the first brightness level (i.e. the maximum brightness). The sub-pixel 108Da (or the fourth-brightness level second pixel 108D) includes a fourth semi-opaque semiconductor layer 112D. As illustrated in FIG. 2D, the pixel electrode 110 of the fourth-brightness level second pixel 108D overlaps with the fourth semi-opaque semiconductor layer 112D by an area equal to 100% of the first area plus_to_times the second area to achieve the fourth brightness level which is 0.25 times the first brightness level.

FIG. 2E shows a sub-pixel 108Ea of the dark second pixel 108E, which has no brightness level and does not emit light. The sub-pixel 108Ea of dark second pixel 108E can include a pixel electrode 110 and a light-shielding layer 122 completely covering the pixel electrode 110 and completely shield the light emitted from the light-emitting element and corresponding to the sub-pixel 108Ea of the dark second pixel 108E

In addition, the light-shielding layer 122 in the embodiment shown in FIG. 2E has the thickness equal to or greater than the minimum thickness which is able to completely shield the light corresponding to the first brightness level (i.e. the maximum brightness). Therefore, the light-shielding layer 122 can completely shield the light emitted from the light-emitting element and corresponding to the dark second pixel 108E.

The light-shielding layer 122 can be disposed between an array substrate including the pixels and a color filter substrate of the display device 100. In one embodiment, the light-shielding layer 122 is disposed over the color filter substrate. In other embodiments, the light-shielding layer 122 is disposed over the array substrate. In summary, the light-shielding layer 122 can be disposed at any position where the light-shielding layer 122 can shield the light emitted corresponding to the dark second pixel.

The light-shielding layer 122 can include, but is not limited to, black photoresist, black printing ink, black resin or any other suitable light-shielding materials of various colors.

Therefore, in this embodiment, by altering the area of the pixel electrode overlapped by the semi-opaque semiconductor layer in each second pixel, the first-brightness level, second-brightness level, third-brightness level and fourth-brightness level of the second pixels 108 can be achieved. And the dark second pixel can be achieved by utilizing the light-shielding layer.

It should be noted that the exemplary embodiments set forth in FIGS. 2A-2E are merely for the purpose of illustration. In addition to the embodiments set forth in FIGS. 2A-2E, the different brightness levels of the second pixels can be achieved by other methods as shown in FIGS. 3A-3E. Therefore, the inventive concept and scope are not limited to the exemplary embodiments shown in FIGS. 2A-2E.

The following description of FIGS. 3A-3E also takes the embodiment which utilizes the classification method classifying the second pixels into five classes with five brightness levels for example. FIGS. 3A-3E are top views of sub-pixels 108Aa-108Ea corresponding to first-brightness level second pixel 108A to the dark second pixel 108E in FIG. 1A respectively in accordance with some embodiments of the present disclosure. Note that the same or similar elements or layers corresponding to those of the display device are denoted by like reference numerals. The same or similar elements or layers denoted by like reference numerals have the same meaning and will not be repeated for the sake of brevity.

In the embodiment shown in FIGS. 3A-3E, the different brightness levels of the first-brightness level second pixel 108A, the second-brightness level second pixel 108B, the third-brightness level second pixel 108C and the fourth-brightness level second pixel 108D can be achieved by altering the area of the pixel electrode of these second pixels. And the dark second pixel does not include a pixel electrode.

In particular, referring to FIGS. 3A-3D, each of the first-brightness level second pixel 108A, the second-brightness level second pixel 108B, the third-brightness level second pixel 108C and the fourth-brightness level second pixel 108D includes the first pixel electrode 310A, second pixel electrode 310B, third pixel electrode 310C and fourth pixel electrode 310D, respectively. Areas of the first pixel electrode 310A, second pixel electrode 310B, third pixel electrode 310C and fourth pixel electrode 310D are related to the brightness levels of the first-brightness level second pixel 108A, the second-brightness level second pixel 108B, the third-brightness level second pixel 108C and the fourth-brightness level second pixel 108D.

In particular, the second pixel with a higher brightness level has a larger area of the pixel electrode. In addition, sub-pixels of the second pixels with the same brightness level have the same area of the pixel electrode. Furthermore, in FIGS. 3A-3D, the region of the sub-pixel (or the second pixel) which does not correspond to the pixel electrode is covered by a light-shielding layer with sufficient thickness to completely shield the light emitted corresponding to that region.

In particular, in FIG. 3A, the first pixel electrode 310A of the sub-pixel 108Aa of the first-brightness level second pixel 108A has a first area. Subsequently, referring to FIG. 3B, the second pixel electrode 310B of the sub-pixel 108Ba of the second-brightness level second pixel 108B has a second area which is_to_times the first area to achieve the second brightness level which is 0.75 times the first brightness level.

Referring to FIG. 3C, the third pixel electrode 310C of the sub-pixel 108Ca of the third-brightness level second pixel 108C has an third area which is_to_times the first area to achieve the third brightness level which is 0.5 times the first brightness level.

Referring to FIG. 3D, the fourth pixel electrode 310D of the sub-pixel 108Da of the fourth-brightness level second pixel 108D has an fourth area which is_to_times the first area to achieve the fourth brightness level which is 0.25 times the first brightness level.

Referring to FIG. 3E, the dark second pixel 108E, which has no brightness level and does not emit light, does not include any pixel electrode.

Therefore, in this embodiment, by altering the area of the pixel electrode in each second pixel, the first-brightness level, second-brightness level, third-brightness level and fourth-brightness level of the second pixels can be achieved. And the dark second pixel can be achieved by having the dark second pixel including no pixel electrode.

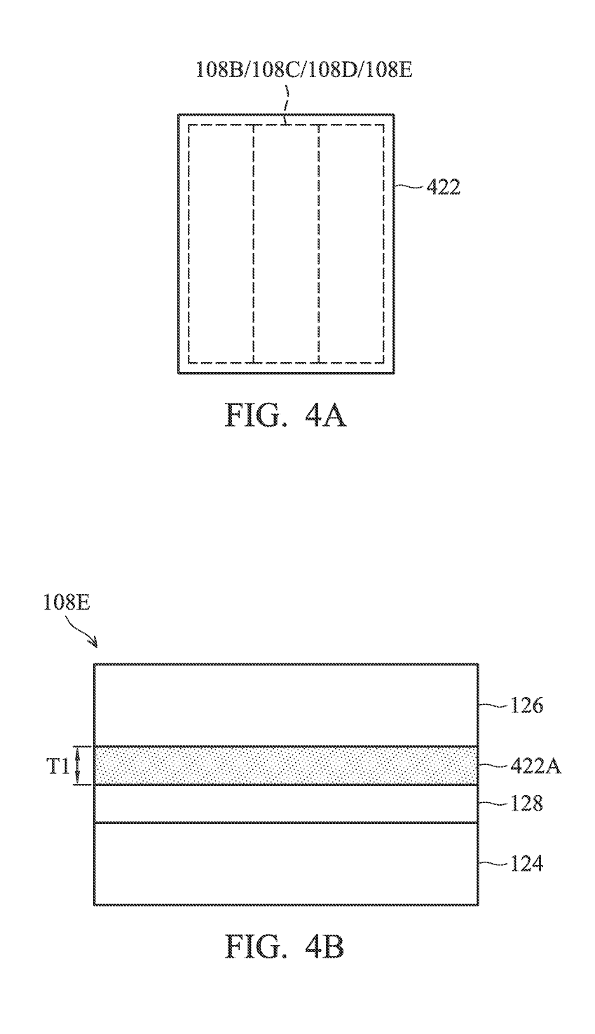

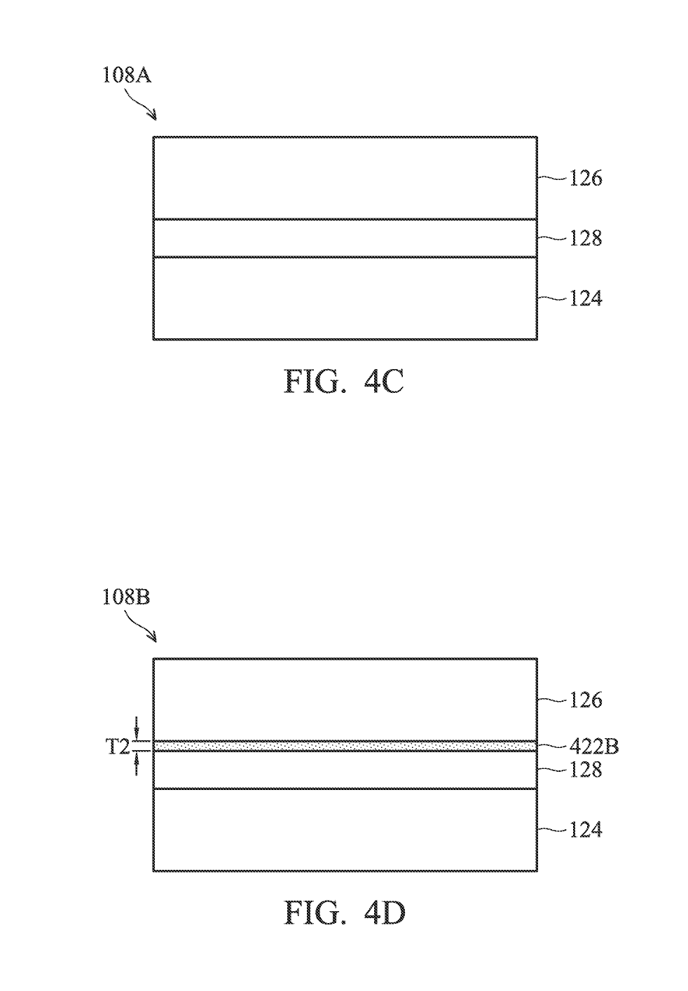

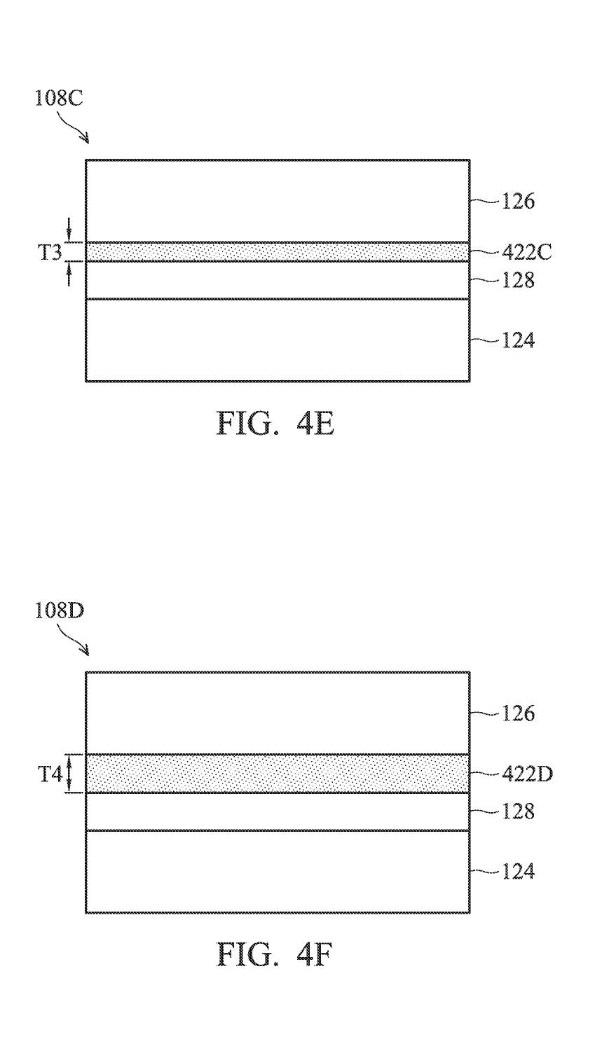

It should be noted that the exemplary embodiments set forth in FIGS. 2A-3E are merely for the purpose of illustration. In addition to the embodiments set forth in FIG. 2A-3E, the different brightness levels of the second pixels can be achieved by other methods as shown in FIGS. 4A-4F. Therefore, the inventive concept and scope are not limited to the exemplary embodiment shown in FIGS. 2A-3E.

The following description of FIGS. 4A-4F also takes the embodiment which utilizes the classification method classifying the second pixels into five classes with five brightness levels for example. FIG. 4A is a top view of the second-brightness level second pixel 108B, the third-brightness level second pixel 108C, the fourth-brightness level second pixel 108D and the dark second pixel 108E in accordance with this embodiment of the present disclosure, and FIGS. 4C, 4D, 4E, 4F and 4B are cross-sectional views of the first-brightness level second pixel 108A, the second-brightness level second pixel 108B, the third-brightness level second pixel 108C, the fourth-brightness level second pixel 108D and the dark second pixel 108E in FIG. 1A respectively in accordance with this embodiment. Note that the same or similar elements or layers corresponding to those of the display device are denoted by like reference numerals. The same or similar elements or layers denoted by like reference numerals have the same meaning and will not be repeated for the sake of brevity.

In the embodiment shown in FIGS. 4A-4F, the different brightness levels of the second-brightness level second pixel 108B, the third-brightness level second pixel 108C, the fourth-brightness level second pixel 108D and the dark second pixel 108E can be achieved by altering the thicknesses of the light-shielding layers 422 (e.g. black matrix layer) disposed corresponding to these second pixels. And there is no light-shielding layer disposed corresponding to the pixel electrode of the first-brightness level second pixel 108A. In addition, in FIG. 4A, the second pixel covered by the light-shielding layers 422 is represented by a dash line.

As shown in FIG. 4A, a plurality of light-shielding layers 422 disposed corresponding to each of the second-brightness level second pixel 108B, the third-brightness level second pixel 108C, the fourth-brightness level second pixel 108D and the dark second pixel 108E. The thicknesses of the light-shielding layers 422 are related to the brightness levels of the second-brightness level second pixel 108B, the third-brightness level second pixel 108C, the fourth-brightness level second pixel 108D and the dark second pixel 108E.

In particular, the second pixel with a higher brightness level corresponds to the light-shielding layer 422 with a smaller thickness. In addition, the second pixels with the same brightness level correspond to the light-shielding layer 422 with the same thickness.

In particular, referring to FIGS. 4B-4F, the plurality of light-shielding layers 422 includes a first light-shielding layer 422A, a second light-shielding layer 422B, a third light-shielding layer 422C and a fourth light-shielding layer 422D. FIG. 4B shows a cross-sectional view of the portion of the display device 100 corresponding to the dark second pixel 108E. As shown in FIG. 4B, the display device 100 includes an array substrate 124, a color filter substrate 126 disposed opposite to the array substrate 124 and a display medium 128 disposed between the array substrate 124 and the color filter substrate 126.

The array substrate 124 can be a transistor substrate with a transistor array, such as a thin film transistor substrate. In addition, the array substrate 124 can include the plurality of first pixels 106 and the plurality of second pixels 108 as shown in FIGS. 1A-1C. The color filter substrate 126 can include a transparent substrate and a color filter layer disposed over the transparent substrate. The transparent substrate can include, but is not limited to, a glass substrate, a ceramic substrate, a plastic substrate, or any other suitable transparent substrate. The color filter layer can include, but is not limited to, a red color filter layer, a green color filter layer, a blue color filter layer, or a color filter layer of any other suitable color. The display medium 128 can be a liquid-crystal material. The liquid-crystal material can include, but is not limited to, nematic liquid crystal, smectic liquid crystal, cholesteric liquid crystal, blue phase liquid crystal, or any other suitable liquid-crystal material.

The light-shielding layer 422 can be disposed at any position where it can shield the light emitted corresponding to the second pixel. The light-shielding layer 422 can be disposed between the array substrate 124 and the color filter substrate 126. And in the embodiments shown in FIGS. 4B, 4D-4F, the light-shielding layer 422 is disposed over the color filter substrate 126. However, in other embodiments, the light-shielding layer 422 can be disposed over the array substrate 124.

Referring to FIG. 4B, the first light-shielding layer 422A is disposed corresponding to the dark second pixel 108E and has a first thickness T1. The first thickness T1 refers to the minimum thickness of the light-shielding layer 422A which is able to completely shield the light corresponding to the first brightness level (i.e. the maximum brightness) of the first-brightness level second pixel.

Subsequently, FIG. 4C shows the first-brightness level second pixel 108A. As illustrated in FIG. 4C, there is no light-shielding layer disposed corresponding to the pixel electrode of the first-brightness level second pixel 108A, which has the first brightness level (i.e. the maximum brightness).

Subsequently, Referring to FIG. 4D, the second light-shielding layer 422B is disposed corresponding to the second-brightness level second pixel 108B and has a second thickness T2 which is_to_times the first thickness T1 to achieve the second brightness level which is 0.75 times the first brightness level.

Referring to FIG. 4E, the third light-shielding layer 422C is disposed corresponding to the third-brightness level second pixel 108C and has an third thickness T3 which is_to_times the first thickness T1 to achieve the third brightness level which is 0.5 times the first brightness level.

Referring to FIG. 4F, the fourth light-shielding layer 422D is disposed corresponding to the fourth-brightness level second pixel 108D and has an fourth thickness T4 which is_to_times the first thickness T1 to achieve the fourth brightness level which is 0.25 times the first brightness level.

Therefore, in this embodiment, altering the thicknesses of the light-shielding layers disposed corresponding to each of the second pixels other than the first-brightness level second pixel, the different brightness levels of the second-brightness level second pixel, third-brightness level second pixel, fourth-brightness level second pixel and the dark second pixel can be achieved. And there is no light-shielding layer disposed corresponding to the pixel electrode of the first-brightness level second pixel 108A.

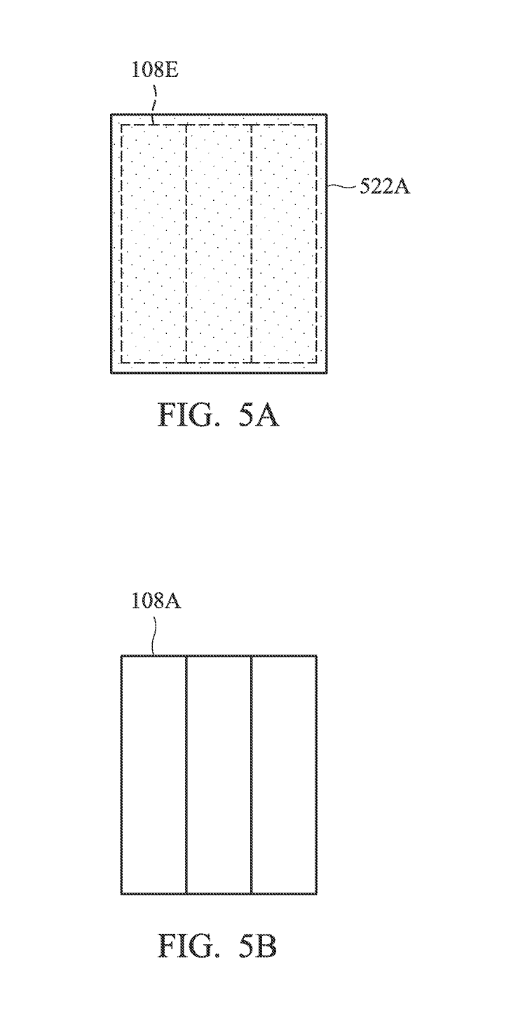

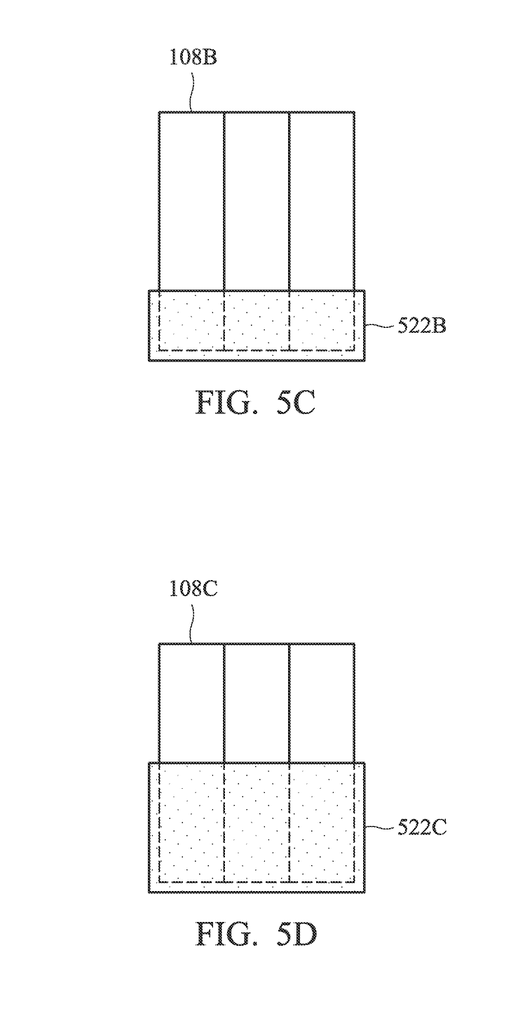

It should be noted that the exemplary embodiments set forth in FIGS. 2A-4F are merely for the purpose of illustration. In addition to the embodiments set forth in FIG. 2A-4F, the different brightness levels of the second pixels can be achieved by other methods as shown in FIGS. 5A-5E. Therefore, the inventive concept and scope are not limited to the exemplary embodiments shown in FIGS. 2A-4F.

The following description of FIGS. 5A-5E also takes the embodiment which utilizes the classification method classifying the second pixels into five classes with five brightness levels for example. FIGS. 5A, 5B, 5C, 5D and 5E are top views of the dark second pixel 108E, the first-brightness level second pixel 108A, the second-brightness level second pixel 108B, the third-brightness level second pixel 108C and the fourth-brightness level second pixel 108D respectively in accordance with this embodiment. Note that the same or similar elements or layers corresponding to those of the display device are denoted by like reference numerals. The same or similar elements or layers denoted by like reference numerals have the same meaning and will not be repeated for the sake of brevity.

In addition, in FIGS. 5A and 5C-5E, the portion of the second pixel covered by the light-shielding layers is represented by a dash line.

In the embodiment shown in FIGS. 5A-5E, the different brightness levels of the second pixels can be achieved by altering the areas of the second-brightness level second pixel 108B, the third-brightness level second pixel 108C and the fourth-brightness level second pixel 108D and the dark second pixel 108E overlapped by the light-shielding layers. And there is no light-shielding layer disposed corresponding to the pixel electrode of the first-brightness level second pixel 108A. Specifically, the light-shielding layer including a plurality of light-shielding patterns disposed corresponding to at least one second pixel 108, and areas of the second pixels 108 except the first-brightness level second pixel 108A overlapped by the light-shielding patterns are related to the areas of the outer regions. In other words, the second pixel 108 except the first-brightness level second pixel 108A with a larger outer region has a larger overlapping area.

In particular, referring to FIGS. 5A and 5C-5E, a first light-shielding layer 522A, a second light-shielding layer 522B, a third light-shielding layer 522C and a fourth light-shielding layer 522D are disposed corresponding to each of the dark second pixel 108E, the second-brightness level second pixel 108B, the third-brightness level second pixel 108C and the fourth-brightness level second pixel 108D respectively. And the areas of the dark second pixel 108E, the second-brightness level second pixel 108B, the third-brightness level second pixel 108C and the fourth-brightness level second pixel 108D overlapped by the first light-shielding layer 522A, the second light-shielding layer 522B, the third light-shielding layer 522C and the fourth light-shielding layer 522D respectively are related to the brightness levels of these second pixels.

In particular, the second pixel with a higher brightness level has a smaller overlapping area overlapped by the light-shielding layer. In addition, the second pixels with the same brightness level have the same overlapping area overlapped by the light-shielding layer.

Furthermore, all of the first light-shielding layer 522A, the second light-shielding layer 522B, the third light-shielding layer 522C and the fourth light-shielding layer 522D in the embodiment shown in FIGS. 5A-5E have a thickness equal to or greater than the minimum thickness of the light-shielding layer which is able to completely shield the light corresponding to the first brightness level (i.e. the maximum brightness) of the first-brightness level second pixel. Therefore, the first light-shielding layer 522A, the second light-shielding layer 522B, the third light-shielding layer 522C and the fourth light-shielding layer 522D can completely shield the light where they cover.

Referring to FIG. 5A, the first light-shielding layer 522A is disposed corresponding to the dark second pixel 108E and completely covers the dark second pixel 108E. Therefore, the light emitted from the light-emitting element and corresponding to the dark second pixel 108E is completely shielded, and the dark second pixel 108E has no brightness level and does not emit light.

Referring to FIG. 5B, there is no light-shielding layer disposed corresponding to the pixel electrode of the first-brightness level second pixel 108A. Therefore, the first-brightness level second pixel 108A can have the first brightness level (i.e. the maximum brightness).

Referring to FIG. 5C, the second light-shielding layer 522B is disposed corresponding to the second-brightness level second pixel 108B and covers_to_of the total area of the second-brightness level second pixel 108B to achieve the second brightness level which is 0.75 times the first brightness level.

Referring to FIG. 5D, the third light-shielding layer 522C is disposed corresponding to the third-brightness level second pixel 108C and covers_to_of the total area of the third-brightness level second pixel 108C to achieve the third brightness level which is 0.5 times the first brightness level.

Referring to FIG. 5E, the fourth light-shielding layer 522D is disposed corresponding to the fourth-brightness level second pixel 108D and covers_to_of the total area of the fourth-brightness level second pixel 108D to achieve the fourth brightness level which is 0.25 times the first brightness level.

In addition, referring to FIGS. 5A-5E, the ratio of the area covered by the light-shielding layer to the total area for each sub-pixel in one pixel can be the same in order to keep the light mixing ratio constant for that pixel.

It should be noted that the exemplary embodiments set forth in FIGS. 4A-5E are merely for the purpose of illustration. In addition to the embodiments set forth in FIGS. 4A-5E, the light-shielding layer can be disposed over the color filter substrate. Therefore, the inventive concept and scope are not limited to the exemplary embodiments shown in FIGS. 4A-5E.

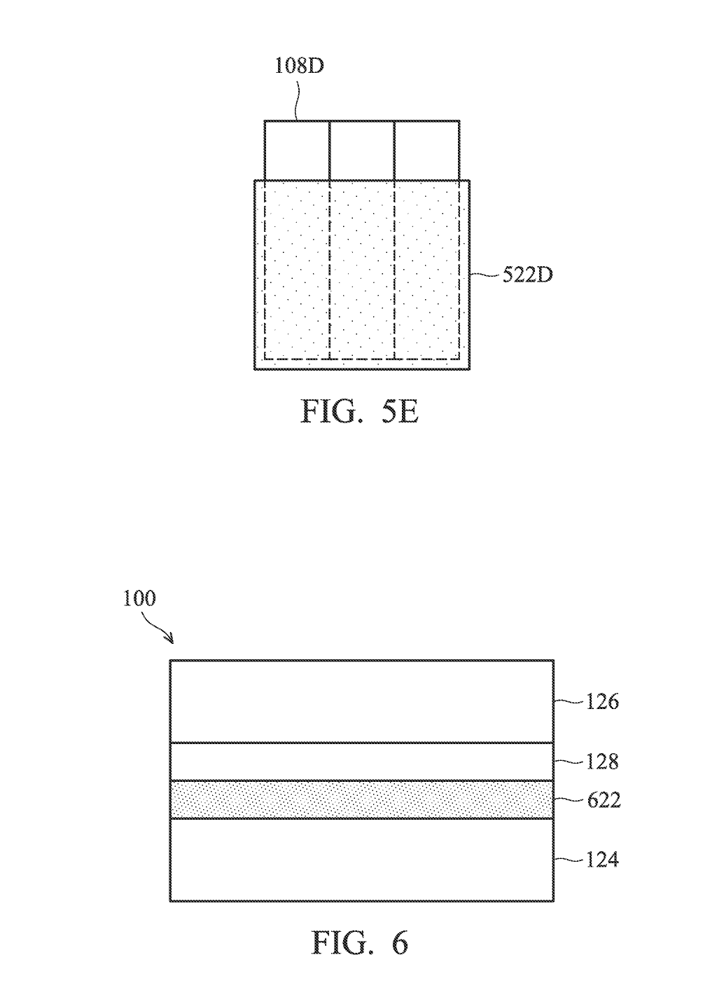

FIG. 6 is a cross-sectional view of a display device 100 in accordance with a further embodiment of the present disclosure. Note that the same or similar elements or layers corresponding to those of the display device are denoted by like reference numerals. The same or similar elements or layers denoted by like reference numerals have the same meaning and will not be repeated for the sake of brevity. The difference between the embodiments shown in FIGS. 6 and 4A-5E is that the light-shielding layer 622 is disposed over the array substrate 124 rather than the color filter substrate 126.

In addition, it should be noted that although the embodiments shown in FIGS. 2A-5E take the second pixels classified into five classes with five brightness levels for example, the four methods described in the embodiments shown in FIGS. 2A-5E can be used to achieve any other amount or levels of brightness of the second pixels. For example, when the second pixels are classified into six classes with six brightness levels, any of the four methods described in the embodiments shown in FIGS. 2A-5E can be used to achieve these six brightness levels.

FIG. 7 is an image of a top view of a display device. In the upper-half portion of the display device, the brightness levels of the pixels disposed at the periphery of the display region (corresponding to the second pixels mentioned in the embodiments shown in FIGS. 1A-5E) are altered according to the present disclosure. In contrast, in the lower-half portion of the display device, the brightness levels of the pixels disposed at the periphery of the display region are not altered. In other words, all the pixels in the lower-half portion of the display device have the same brightness level.

As shown in FIG. 7, in the upper-half portion of the display device, a non-rectangular display border without a micro jigsaw border or a micro zigzag border can be achieved according to the present disclosure. In contrast, without applying the method of the present disclosure, the lower-half portion of the display device can only display a non-rectangular display border with a micro jigsaw border or a micro zigzag border. In other words, a non-rectangular display border of the present disclosure will show smoother border edge for human eyes than the bottom-half portion of the display.

In summary, through altering the brightness levels of the pixels disposed at the periphery of the display region in the display device, the present disclosure can display a non-rectangular display border with making a viewer feels smoother border than actual pixel border like a micro jigsaw border or a micro zigzag border and thus further improve the display quality of the display device.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein can be varied while remaining within the scope of the present disclosure. Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein can be utilized according to the present disclosure. Accordingly, the appended claims are intended to include within their scope such processes, machines, manufacture, compositions of matter, means, methods, or steps.

What is claimed is:

1. A display device, comprising:
a display region and a non-display region adjacent to the display region, wherein the display region is non-rectangular and comprises a plurality of first pixels and a plurality of second pixels, wherein the plurality of second pixels is disposed at a periphery of the display region and surrounds the plurality of first pixels,
wherein when the plurality of first pixels and the plurality of second pixels are supplied with a same operating voltage, the plurality of second pixels has two or more brightness levels.

2. The display device as claimed in claim 1, further comprising a virtual edge curve across the plurality of second pixels and defining the non-rectangular display border.

3. The display device as claimed in claim 2, wherein
the virtual edge curve divides each second pixel into an inner region and an outer region, wherein the inner region is closer to the plurality of first pixels and the outer region is farther away from the plurality of first pixels,
wherein when the plurality of first pixels and the plurality of second pixels are supplied with the same operating voltage, the brightness level of each second pixel is related to an area of the inner region thereof.

4. The display device as claimed in claim 3, wherein when the plurality of first pixels and the plurality of second pixels are supplied with the same operating voltage,
the plurality of first pixels has a first brightness level, and
if the area of the inner region of one second pixel is greater than or equal to 0.875 times a total area of the second pixel, the second pixel has the first brightness level and is referred to as a first-brightness level second pixel,
if the area of the inner region of one second pixel is greater than or equal to 0.625 times the total area of the second pixel and is less than 0.875 times the total area of the second pixel, the second pixel has a second brightness level which is 0.75 times the first brightness level and is referred to as a second-brightness level second pixel,
if the area of the inner region of one second pixel is greater than or equal to 0.375 times the total area of the second pixel and is less than 0.625 times the total area of the second pixel, the second pixel has a third brightness level which is 0.5 times the first brightness level and is referred to as a third-brightness level second pixel,
if the area of the inner region of one second pixel is greater than or equal to 0.125 times the total area of the second pixel and is less than 0.375 times the total area of the second pixel, the second pixel has a fourth brightness level which is 0.25 times the first brightness level and is referred to as a fourth-brightness level second pixel, and
if the area of the inner region of one second pixel is less than 0.125 times the total area of the second pixel, the second pixel has no brightness level and is referred to as a dark second pixel.

5. The display device as claimed in claim 2, wherein the virtual edge curve has one or more curvature radii.

6. The display device as claimed in claim 2, wherein the virtual edge curve is a circle, an oval, or a closed curve with two or more different curvature radii.

7. The display device as claimed in claim 2, wherein the virtual edge curve only passes through the plurality of second pixels and does not pass through the non-display region and the plurality of first pixels.

8. The display device as claimed in claim 1, wherein the plurality of second pixels completely encloses the plurality of first pixels.

9. The display device as claimed in claim 1, wherein sides of each first pixel only contact other first pixels or the second pixels, and do not contact the non-display region.

10. The display device as claimed in claim 1, wherein each first pixel and second pixel include at least three sub-pixel of different color.

11. The display device as claimed in claim 3, each of the second pixels comprises a pixel electrode and a semi-opaque semiconductor layer, wherein areas of the pixel electrodes overlapped with the semi-opaque semiconductor layer is inversely related to the area of the inner region.

12. The display device as claimed in claim 4,
wherein each of the first-brightness level second pixel, the second-brightness level second pixel, the third-brightness level second pixel, and the fourth-brightness level second pixel comprises a pixel electrode,
wherein each of the first-brightness level second pixel, the second-brightness level second pixel, the third-brightness level second pixel, and the fourth-brightness level second pixel respectively comprises a first semi-opaque semiconductor layer, a second semi-opaque semiconductor layer, a third semi-opaque semiconductor layer and a fourth semi-opaque semiconductor layer disposed corresponding to the pixel electrode,
wherein areas of the pixel electrodes overlapped with the first semi-opaque semiconductor layer, the second semi-opaque semiconductor layer, the third semi-opaque semiconductor layer or the fourth semi-opaque semiconductor layer are related to the brightness levels of the second pixels, wherein the second pixel with a higher brightness level has a smaller overlapping area.

13. The display device as claimed in claim 12, wherein
the first-brightness level second pixel comprises the first semi-opaque semiconductor layer, wherein the pixel electrode of the first-brightness level second pixel comprises a first portion which is overlapped with the first semi-opaque semiconductor layer and a second portion which is not overlapped with the first semi-opaque semiconductor layer, wherein the first portion has a first area and the second portion has a second area,
the second-brightness level second pixel comprises the second semi-opaque semiconductor layer, wherein the pixel electrode of the second-brightness level second pixel overlaps with the second semi-opaque semiconductor layer by an area equal to 100% of the first area plus_to_times the second area,
the third-brightness level second pixel comprises the third semi-opaque semiconductor layer, wherein the pixel electrode of the third-brightness level second pixel overlaps with the third semi-opaque semiconductor layer by an area equal to 100% of the first area plus_to_times the second area,
the fourth-brightness level second pixel comprises the fourth semi-opaque semiconductor layer, wherein the pixel electrode of the fourth-brightness level second pixel overlaps with the fourth semi-opaque semiconductor layer by an area equal to 100% of the first area plus_to_times the second area, and
the dark second pixel comprises a pixel electrode and a light-shielding layer completely covering the pixel electrode.

14. The display device as claimed in claim 11, wherein the semi-opaque semiconductor layer comprises poly-silicon, amorphous silicon, indium gallium zinc oxide (IGZO), or a combination thereof.

15. The display device as claimed in claim 4, wherein
each of the first-brightness level second pixel, the second-brightness level second pixel, the third-brightness level second pixel, and the fourth-brightness level second pixel comprises a pixel electrode, wherein areas of the pixel electrodes are related to the brightness levels of the second pixels, wherein the second pixel with a higher brightness level has a larger area of the pixel electrode,
the dark second pixel does not comprise a pixel electrode.

16. The display device as claimed in claim 11,
wherein the pixel electrode comprises a first pixel electrode, a second pixel electrode, a third pixel electrode and a fourth pixel electrode,
wherein the first-brightness level second pixel comprises the first pixel electrode having a first area,
the second-brightness level second pixel comprises the second pixel electrode having a second area which is_to_times the first area,
the third-brightness level second pixel comprises the third pixel electrode having an third area which is_to_times the first area, and
the fourth-brightness level second pixel comprises the fourth pixel electrode having an fourth area which is_to_times the first area.

17. The display device as claimed in claim 4, wherein the display device further comprising:
a plurality of light-shielding layers disposed corresponding to each of the second-brightness level second pixel, the third-brightness level second pixel, the fourth-brightness level second pixel and the dark second pixel,
wherein thicknesses of the light-shielding layers are related to the brightness levels of the second pixels, wherein the second pixel with a higher brightness level corresponds to the light-shielding layer with a smaller thickness.

18. The display device as claimed in claim 17, wherein the plurality of light-shielding layers comprise:
a first light-shielding layer disposed corresponding to the dark second pixel and having a first thickness,
a second light-shielding layer disposed corresponding to the second-brightness level second pixel and having a second thickness which is_to_times the first thickness,
a third light-shielding layer disposed corresponding to the third-brightness level second pixel and having an third thickness which is_to_times the first thickness, and
a fourth light-shielding layer disposed corresponding to the fourth-brightness level second pixel and having an fourth thickness which is_to_times the first thickness,

19. The display device as claimed in claim 3, wherein the display device further comprising:
a light-shielding layer including a plurality of light-shielding patterns disposed corresponding to at least one second pixel, wherein areas of the second pixels overlapped by the light-shielding patterns are related to the areas of the outer regions, wherein the second pixel with a larger outer region has a larger overlapping area.

20. The display device as claimed in claim 19, wherein:
when the plurality of first pixels and the plurality of second pixels are supplied with the same operating voltage,
the plurality of first pixels has a first brightness level, and
if the area of the inner region of one second pixel is greater than or equal to 0.875 times a total area of the second pixel, the second pixel has the first brightness level and is referred to as a first-brightness level second pixel,
if the area of the inner region of one second pixel is greater than or equal to 0.625 times the total area of the second pixel and is less than 0.875 times the total area of the second pixel, the second pixel has a second brightness level which is 0.75 times the first brightness level and is referred to as a second-brightness level second pixel,
if the area of the inner region of one second pixel is greater than or equal to 0.375 times the total area of the second pixel and is less than 0.625 times the total area of the second pixel, the second pixel has a third brightness level which is 0.5 times the first brightness level and is referred to as a third-brightness level second pixel,
if the area of the inner region of one second pixel is greater than or equal to 0.125 times the total area of the second pixel and is less than 0.375 times the total area of the second pixel, the second pixel has a fourth brightness level which is 0.25 times the first brightness level and is referred to as a fourth-brightness level second pixel, and
if the area of the inner region of one second pixel is less than 0.125 times the total area of the second pixel, the second pixel has no brightness level and is referred to as a dark second pixel,
wherein the plurality of light-shielding layers comprise:
a first light-shielding layer disposed corresponding to the dark second pixel and completely covering the dark second pixel,
a second light-shielding layer disposed corresponding to the second-brightness level second pixel and covering_to_of a total area of the second-brightness level second pixel,
a third light-shielding layer disposed corresponding to the third-brightness level second pixel and covering_to_of a total area of the third-brightness level second pixel, and
a fourth light-shielding layer disposed corresponding to the fourth-brightness level second pixel and covering_to_of a total area of the fourth-brightness level second pixel.
